(19) United States
(12) Patent Application Publication
(10) Pub. No.: US 2026/0217028 A1
(43) Pub. Date: Jul. 30, 2026

(54) NOZZLE PLATE FOR A DROPLET EJECTION HEAD AND METHOD FOR MANUFACTURING THE SAME

(71) Applicant: XAAR TECHNOLOGY LIMITED, Huntingdon, Cambridgeshire (GB)

(72) Inventor: Jürgen BRÜNAHL, Huntingdon, Cambridgeshire (GB)

(21) Appl. No.: 19/151,781

(22) PCT Filed: Jan. 30, 2024
(86) PCT No.: PCT/GB2024/050249

§ 371 Date: Jul. 29, 2025

(30) Foreign Application Priority Data
Jan. 31, 2023 (GB) 2301389.9

(51) Int. Cl. B41J 2/14

(52) U.S. Cl. CPC B41J 2/1433; B41J 2/14209; B41J 2002/14362; B41J 2002/14475; B41J 2002/14483

(57) ABSTRACT

A nozzle plate for a droplet ejection head. The nozzle plate includes one or more strips, the strips including one or more sub-strips, wherein said one or more sub-strips have one or more droplet ejection nozzles. The nozzle plate also includes one or more frames having one or more openings. Each of said one or more sub-strips fit within a corresponding opening in said one or more frames. Together, said one or more strips and said one or more frames present a media facing surface of the nozzle plate. Also provided are a droplet ejection head including one or more nozzle plates, a droplet ejection apparatus including one or more of said droplet ejection heads, and methods of manufacture of the nozzle plates.

The present disclosure relates to a nozzle plate for a droplet ejection head. The nozzle plate may be particularly suitable for use in a droplet ejection head such as a drop-on-demand inkjet printhead, or, more generally, for use in a droplet ejection apparatus and, specifically, a droplet ejection apparatus comprising one or more nozzle plates. The nozzle plate provides one or more arrays of nozzles, where at least one nozzle may be fluidically connected to a respective fluid chamber, comprising an actuator. The actuator is operable to cause the release, in an ejection direction, of liquid droplets through a nozzle in response to electrical signals. In many applications a robust nozzle plate, able to withstand the rigours of the operating environment, and to prevent damage during cleaning, is desirable. Such a robust nozzle plate may comprise a silicon nozzle plate or the like. However, the cost of such a robust nozzle plate may be high. The present disclosure relates to a nozzle plate with greater robustness at reduced cost. The present disclosure further describes a method of manufacturing such a nozzle plate.

### BACKGROUND

Droplet ejection heads are now in widespread usage, whether in more traditional applications, such as inkjet printing, or in 3D printing, or other rapid prototyping techniques. Accordingly, the liquids, e.g., inks, may have novel chemical properties to adhere to new substrates and increase the functionality of the deposited material. Droplet ejection heads have been developed that are capable of use in industrial applications, for example for printing directly onto substrates, such as ceramic tiles or textiles, or to form elements such as colour filters in LCD or OLED displays for flat-screen televisions. Such industrial printing techniques using droplet ejection heads allow for short production runs, customization of products and even printing of bespoke designs. It will therefore be appreciated that droplet ejection heads continue to evolve and specialise so as to be suitable for new and/or increasingly challenging applications. However, while a great many developments have been made in the field of droplet ejection heads, there remains room for improvements.

In recent years, there has been increasing interest in using silicon nozzle plates due to the precision with which they can be formed and their robustness, which makes them desirable compared to nozzle plates made from softer materials, such as polyimide. For example, in some industrial applications, in operation, there may be problems with the nozzle plate accidentally getting some fluid, for example a curable ink, on the media facing surface, and such ink getting cured there. For some such cured inks, the cured ink may only be removed by strong rubbing actions which are better tolerated by nozzle plates made of silicon (or other similarly strong materials), which may withstand harsh cleaning procedures without being damaged, for example, scratched. Those nozzle plates would solve the robustness problem, but the cost may be high. This is because nozzle plates can be quite large, and, in some instances, as little as 6 or 7 nozzle plates will fit on a 6-inch silicon wafer (imperial measurements are generally still used for these wafers).

The present invention has been devised in view of the aforementioned problem.

### SUMMARY OF THE INVENTION

Aspects of the invention are set out in the appended independent claims, while details of particular embodiments of the invention are set out in the appended dependent claims.

According to a first aspect of the invention, there is provided a nozzle plate for a droplet ejection head, the nozzle plate comprising: one or more strips, comprising one or more sub-strips, wherein said one or more sub-strips comprise one or more droplet ejection nozzles; and one or more frames, comprising one or more openings; wherein each of said one or more sub-strips fit within a corresponding opening in said one or more frames, such that said one or more strips and said one or more frames together present a media facing surface of the nozzle plate.

According to a second aspect of the invention, there is provided a droplet ejection head comprising one or more nozzle plates according to the first aspect, and one or more fluid chambers fluidically connected to one or more of said droplet ejection nozzles; wherein said fluid chambers comprise an actuator actuable to eject a droplet of fluid from one of said one or more droplet ejection nozzles in response to ejection instructions.

According to a third aspect of the invention, there is provided a droplet ejection apparatus comprising one or more droplet ejection heads according to the second aspect.

According to a fourth aspect of the invention there is provided a method of manufacturing a nozzle plate for a droplet ejection head, the method comprising:
forming a release layer on a top surface of a substrate;
forming a seed layer on top of the release layer;
placing one or more sub-strips on the seed layer and holding them using a temporary adhesive;
forming one or more frames around the one or more sub-strips such that each of said one or more sub-strips fit within a corresponding opening in said one or more frames; and
releasing the nozzle plate from the substrate.

According to a fifth aspect of the invention there is provided an alternative method of manufacturing a nozzle plate for a droplet ejection head comprising:
forming a frame;
forming one or more openings in said frame such that there is a supporting ledge in each of said openings;
placing adhesive on a portion of said supporting ledge and/or said opening boundary edges in said openings;
placing one or more sub-strips in each of said openings such that a portion of said sub-strip is supported by said supporting ledge; and
curing said adhesive so as to attach said sub-strips to said frame.

### BRIEF DESCRIPTION OF THE DRAWINGS

FIG. 1A depicts a schematic representation of a nozzle plate according to an embodiment of the invention, comprising a frame and two strips, each comprising a sub-strip.

FIG. 1B depicts an end view of the embodiment of FIG. 1A showing the nozzle plate thickness.

FIG. 2A depicts a schematic representation of a nozzle plate according to another embodiment, similar to that of FIG. 1A, but comprising a single strip divided into two sub-strips.

FIG. 2B depicts an end view of the embodiment of FIG. 2A showing the nozzle plate thickness and the fluid chambers below the nozzle plate.

FIG. 2C depicts a side view of the embodiment of FIG. 2A showing the nozzle plate and the fluid chambers below the nozzle plate.

FIG. 3 depicts a schematic representation of a nozzle plate according to another embodiment, similar to that of FIG. 1A, further comprising an outer frame.

FIG. 4 depicts a schematic representation of a nozzle plate according to another embodiment similar to that of FIG. 3 where there are a plurality of bridges connecting the two frames.

FIG. 5 depicts a schematic representation of a nozzle plate according to another embodiment similar to that of FIG. 2A where the strip comprises a plurality of sub-strips with stepped portions.

FIG. 6 depicts a schematic representation of a nozzle plate according to another embodiment similar to that of FIG. 2A where the sub-strips are staggered and non-uniform.

FIG. 7A depicts a schematic representation of part of a nozzle plate according to another embodiment comprising a frame with a supporting ledge.

FIG. 7B depicts an end view of the part of the nozzle plate of FIG. 7A.

FIG. 7C depicts a schematic representation of an embodiment of a nozzle plate comprising the frame of FIG. 7A and FIG. 7B with two strips inserted into the frame and supported by the supporting ledge. FIG. 8A depicts a schematic representation of another embodiment of a nozzle plate similar to that of FIG. 7C.

FIG. 8B depicts an end view of the nozzle plate of FIG. 8A.

FIG. 9A depicts a first step in a manufacturing process for a nozzle plate according to an embodiment. FIG. 9B depicts a second step in a manufacturing process for a nozzle plate according to an embodiment.

FIG. 9C depicts a third step in a manufacturing process for a nozzle plate according to an embodiment.

FIG. 9D depicts a fourth step in a manufacturing process for a nozzle plate according to an embodiment.

FIG. 9E depicts a fifth step in a manufacturing process for a nozzle plate according to an embodiment.

FIG. 9F depicts a sixth step in a manufacturing process for a nozzle plate according to an embodiment.

It should be noted that the drawings are not to scale and that certain features may be shown with exaggerated sizes so that these are more clearly visible.

### DETAILED DESCRIPTION OF THE DRAWINGS

Embodiments and their various implementations will now be described with reference to the drawings. Throughout the following description, like reference numerals are used for like elements where appropriate.

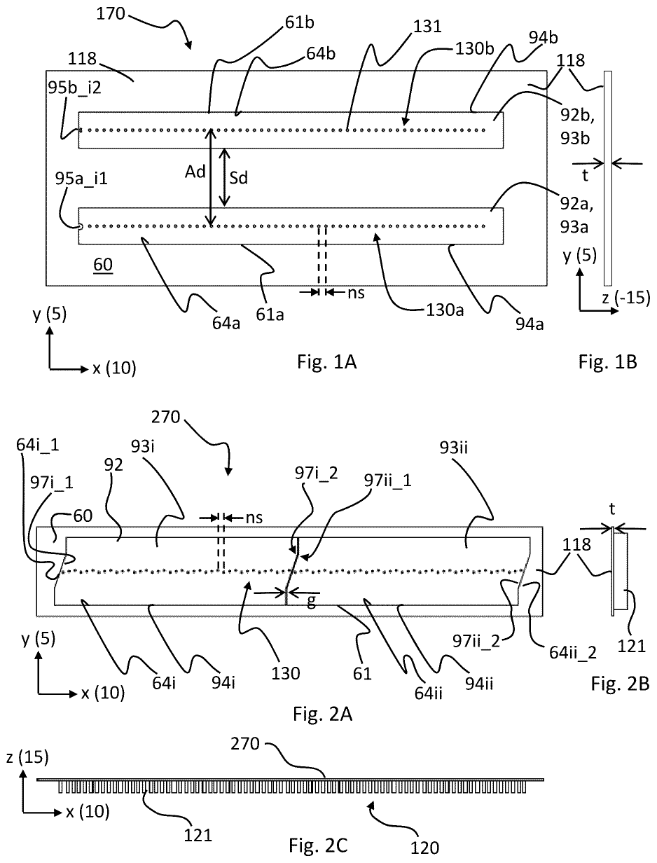

FIG. 1A depicts a schematic representation of a nozzle plate 170 for a droplet ejection head according to an embodiment, comprising a frame 60 and two strips 92a, 92b. Each strip 92a, 92b may comprise one or more sub-strips 93. In the embodiment of FIG. 1A, each strip 92a, 92b comprises a sub-strip 93a, 93b, respectively. FIG. 1B depicts an end view of the embodiment of FIG. 1A, showing that the nozzle plate 170 has a thickness t in an ejection direction 15, where the ejection direction 15 is the direction in which droplets are ejected in use (in this instance, the ejection direction 15 is the negative z-direction). The nozzle plate 170 has a media facing surface 118, which is the outer face of the nozzle plate 170, when it is mounted in a droplet ejection head, and which faces the media towards which the droplets are ejected (such that, in use, the ejection direction 15 is perpendicular to the media facing surface 118). It can be seen that the nozzle plate 170 is arranged such that there are two strips 92a, 92b each comprising a sub-strip 93a, 93b respectively, the sub-strips 93a, 93b each comprising one or more droplet ejection nozzles 131; and a frame 60 comprising two openings 61a, 61b such that each of the sub-strips 93a, 93b is surrounded by a respective one of the openings 61a, 61b, and each of the openings 61a, 61b is arranged adjacent to the outer perimeter edge 94a, 94b of a respective one of said sub-strips 93a, 93b. Together, the strips 92a, 92b and the frame 60 present the media facing surface 118 of the nozzle plate 170. It can further be seen that the boundary edges 64a, 64b of the openings 61a, 61b are conformal to the shape of the outer perimeter edges 94a, 94b respectively.

Each strip 92a, 92b comprises a plurality of nozzles 131 arranged in respective arrays 130a, 130b and extending in an array direction 10. The strips 92a, 92b are arranged adjacent to each other but separated by a separation distance Sd in a spacing direction 5. In the embodiment of FIG. 1A, there are two strips 92a, 92b but more generally the nozzle plate 170 may comprise one or more strips 92 arranged such that the droplet ejection nozzles 131 are arranged in one or more nozzle arrays 130a, 130b extending in an array direction 10. Further, where there are two or more such strips 92 adjacent strips 92 may be offset by a separation distance Sd in a spacing direction 5 from each other, where Sd is measured between adjacent and aligned outer edges of the respective strips 92, as seen in FIG. 1A. It can further be seen from FIG. 1A that the strips 92a, 92b are aligned with each other at either end in the array direction 10, but it may be understood that this is by no means essential and, in other arrangements, they may be offset from each other in the array direction 10, with the separation distance Sd being measured by projecting from the edges of the strips 92 in the array direction 10.

It can be seen from FIG. 1A that the sub-strips 93a, 93b both comprise indentation anchors 95a_i1, 95b_i2 at one end of the strips 92a, 92b in the array direction 10. Examples of two different types of indentation anchors 95 are shown, a part-circle 95a_i1 and a T-shape 95b_i2. Herein, by indentation it is meant that the anchor 95 comprises removing material from the sub-strip 93a, 93b and filling the indentation so formed with material attached to or comprised in the frame 60. It may generally be understood that the anchors 95 need not be indentation anchors 95_i; in some arrangements, the nozzle plate 170 may comprise anchors 95 that are protrusions 95_p and/or indentations 95_i. Still further, it may be understood that the two shapes of indentation anchors 95_i depicted in FIG. 1A are by no means limiting and that any suitable shape may be used. Further, the anchors may be the same or different shapes on different sub-strips 93. Still further, it may be understood that, while the indentation anchors 95 are shown at one end of the sub-strips 93a, 93b in FIG. 1A, this is by no means essential, and they may be formed at any suitable point on a respective outer perimeter edge 94 of a sub-strip 93. It may also be understood that the anchors need not be aligned between strips 92, and may be located at different positions on different sub-strips 93.

The anchors 95 may be for anchoring a respective sub-strip 93a, 93b in the frame 60. It can be seen that the anchors 95a_i1, 95b_i2 may be arranged on the outer perimeter edge 94 of the respective sub-strips 93a, 93b. In FIG. 1A there is one anchor per sub-strip 93a, 93b, but this is by no means limiting and the one or more sub-strips 93a, 93b may comprise one or more anchors 95 for anchoring the one or more sub-strips 93a, 93b within the frame 60.

It may be generally understood that the strips 92a, 92b and the sub-strips 93a, 93b may comprise a suitably hard-wearing but expensive material, such as silicon. It may further generally be understood that the one or more frames 60 may comprise a suitable material that is less expensive and/or less hard-wearing than the material of the sub-strips 93a, 93b, and hence of the strips 92a, 92b. By constructing the nozzle plate 170 in such a manner, the beneficial properties of the hard-wearing material may be utilised, whilst reducing the overall cost of the nozzle plate 170. The beneficial properties of the hard-wearing material may mean it may be more robust against cleaning operations, such as wiping for example, such that the nozzles may not be damaged in use, or such that damage to the nozzles may be reduced or delayed for longer in use, thereby maintaining a longer life for the nozzle plate, whilst reducing its overall cost.

Considering now FIG. 2A, this depicts a schematic representation of a nozzle plate 270 according to another embodiment, similar to that of FIG. 1A, but comprising one strip 92 divided into two sub-strips 93i, 93ii (as compared to FIG. 1A which comprises two strips 92a, 92b, each comprising a single sub-strip 93a, 93b respectively). FIG. 2B depicts an end view of the embodiment of FIG. 2A showing the nozzle plate thickness t and a plurality of fluid chambers 121 below the nozzle plate 270. The fluid chambers 121 are arranged in an array 120 extending in the array direction 10 that corresponds with the array of nozzles 130, such that there is at least one nozzle 131 per fluid chamber 121, fluidically connected to the fluid chamber 121. The respective fluid chambers 121 may be actuable (or comprise an actuator) to eject one or more droplets of fluid, via the at least one nozzle 131, in response to ejection instructions. FIG. 2C depicts a side view of the embodiment of FIG. 2A showing the nozzle plate 270 and the fluid chambers 121 below the nozzle plate 270.

It can be seen that in FIG. 2A the strip 92 comprises an array 130 of nozzles 131, where the array extends in the array direction 10 and is arranged in the sub-strips 93i, 93ii. It can further be seen that adjacent nozzles 131 in the array 130 are staggered perpendicular to the array direction 10 (i.e., in the spacing direction 5, which in this instance is the y-direction). This staggering of the nozzles 131 may allow different firing regimes, such as multi-phase firing, for example, such as three-phase firing, to be used. Offsetting adjacent nozzles 131 from each other allows for compensation for the phased firing whilst still printing into the same print-line on the print media, for example. It may be understood that staggering the nozzles 131 in this manner is by no means essential, it may depend on how a droplet ejection head is to be operated, and that, in other arrangements, the nozzles 131 in a given nozzle array 130 may all be at the same y-position, as in FIG. 1A.

It can be seen that in the embodiment of FIG. 2A, the sub-strips 93i, 93ii are the same shape and that each of the sub-strips 93i, 93ii comprises staggered edge portions 97i_1, 97i_2, 97ii_1, 97ii_2 arranged on opposing edges of a respective sub-strip 93i, 93ii. In the embodiment of FIG. 2A the staggered edge portions 97i_1, 97i_2, 97ii_1, 97ii_2 are arranged at either end of each respective sub-strip 93i, 93ii in the array direction 10. It can be seen from FIG. 2A that a staggered edge portion 97i_2 on the first of the sub-strips 93i is arranged adjacent to and facing a corresponding staggered edge portion 97ii_1 on the second sub-strip 93ii in a tessellating relationship. This may be to aid in alignment and positioning of the sub-strips 93i, 93ii relative to each other. Further, it can be seen that in this embodiment the staggered edge portions 97i_1, 97ii_2 are arranged on the outer perimeter edges 94i, 94ii of the sub-strips 93i, 93ii at opposite ends of the strip 92 in the array direction 10. It can be seen that the openings 61i, 61ii in the frame 60 have matching staggered edge portions 64i_1, 64ii_2 on their perimeter edges 64i, 64ii arranged adjacent to the respective staggered edge portions 97i_1, 97ii_2 of the sub-strips 93i, 93ii. Such an arrangement may aid in alignment and positioning of the sub-strips 93i, 93ii, and hence the strip 92, relative to the frame 60, and may further aid in alignment of the strip 92 as a whole relative to the frame 60.

It may further be generally understood that, where a respective strip 92 comprises two or more sub-strips 93, there may be a gap g between two sub-strips 93 where they have faces adjacent to each other (see, for example, in FIG. 2A where staggered edge portion 97i_2 is arranged adjacent to and facing staggered edge portion 97ii_1 with a gap g spacing between them). The material in the gap g between the two sub-strips 93i, 93ii may comprise part of the frame 60. The frame 60 may then comprise an opening 61i, 61ii per respective sub-strip 93i, 93ii, which may be separated from each other, in the region where two sub-strips 93 have faces adjacent to each other, by the gap g. It may be understood that the width of the gap g between adjacent sub-strips 93 may be constrained by the nozzle spacing ns, such that the nozzle spacing ns in the array 130 is maintained as the array 130 extends over two or more sub-strips 93. For example, the nozzle pitch or spacing ns might be 150 μm. In order to maintain sufficient sub-strip material around the nozzles 131 that are adjacent to the gap g, between the sub-strips 93, whilst also maintaining the nozzle spacing ns, the gap width might be as little as 20-40 μm.

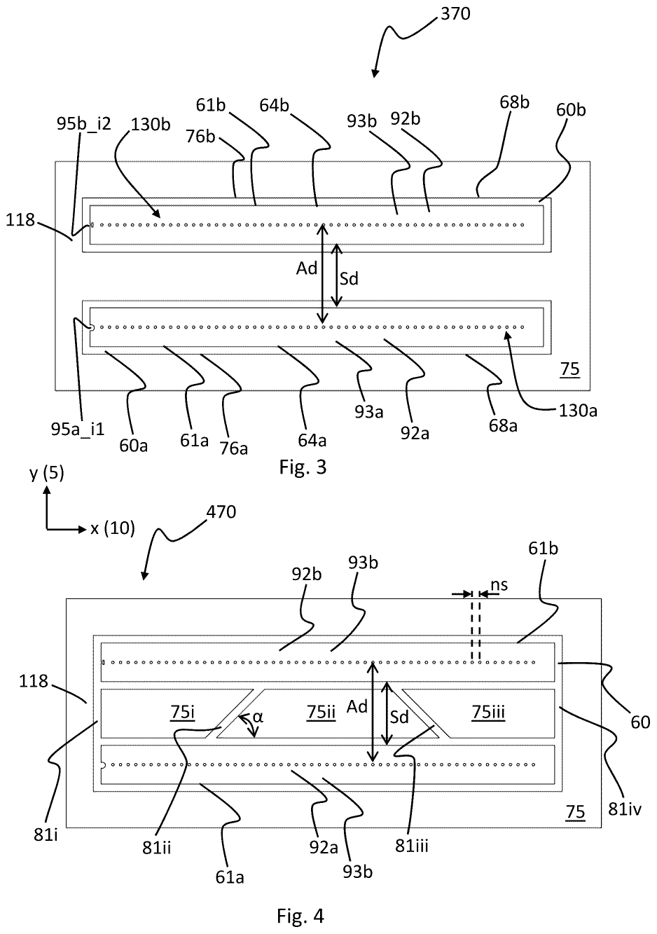

Turning now to FIG. 3, this depicts a schematic representation of a nozzle plate 370 according to another embodiment of the invention. It can be seen that this embodiment is similar to that of FIG. 1A, the main difference is that there is a frame 60a, 60b around each sub-strip 93a, 93b and an outer frame 75 surrounding the two frames 60a, 60b, such that, in this embodiment, each frame 60a, 60b comprises a single opening 61a, 61b respectively. The outer frame 75 comprises two outer openings 76a, 76b such that the frames 60a, 60b are surrounded by a respective one of the two outer openings 76a, 76b. It can be seen that the outer openings 76a, 76b may preferably be conformal to the shape of the outer perimeter edges 68a, 68b of the frames 60a, 60b. This may mean that the outer openings 76a, 76b follow the shape of the outer perimeter edges 68a, 68b closely. For example, if the frames 60a, 60b are formed in the space between the sub-strips 93a, 93b and the outer frame 75, for example by a method such as electroforming, the growth of the frames 60a, 60b, in the space between the sub-strips 93a, 93b and the outer frame 75, will be constrained by the edges of the sub-strips 93a, 93b and the edges of the outer openings 76a, 76b in the outer frame 75 that are adjacent to the growing frames 60a, 60b. Further, when using an alternative method, the frames 60a, 60b may be formed by filling the space between the sub-strips 93a, 93b and the outer frame 75 with a flowable material that may conform to the edges of the sub-strips 93a, 93b and the outer frame 75. The flowable material may then set, or may be cured using any suitable method, so as to form the frames 60a, 60b. It may be generally understood that such methods of growing the frames, or using a flowable material that can subsequently be set or cured, may be applied where suitable to any of the embodiments described herein. More generally any suitable method(s) may be used to form the one or more frames 60 surrounding the one or more sub-strips 93.

FIG. 4 depicts a schematic representation of a nozzle plate 470 according to another embodiment, similar to that of FIG. 3, but where there are a plurality of bridges 81i-81iv connecting the two frames 60a, 60b, such that in the region between the two frames 60a, 60b the outer frame 75 is divided into portions 75i-75iii. In FIG. 4 there are 4 bridges, and in other arrangements there may be one bridge 81, or a plurality of bridges 81i-n where n is a whole number. The bridges 81 may be used to control the separation distance Sd between adjacent strips 92a, 92b. This may aid in greater accuracy of alignment between the strips 92a, 92b and hence improve the nozzle positioning and, in turn, print accuracy. It can be seen that the bridges 81 extend in the spacing direction 5 and are arranged between adjacent spaced apart strips 92 so as to control the distance between said strips 92. It can be seen from FIG. 4 that two of the bridges 81i, 81iv are perpendicular to the array direction 10 and parallel to the spacing direction 5, whilst two of the bridges 81ii, 81iii are inclined at an angle α to the array direction 10. It may be understood that this is by no means essential and other arrangements may be contemplated, such as those where all the bridges are oriented in the same way, or all are oriented in different ways. Still further, whilst a plurality of bridges 81 are depicted in FIG. 4, it may be understood that a single bridge 81 may be sufficient. Still further, there may be a plurality of bridges 81 that may be arranged to form a pattern, such as zigzags or a honeycomb or basket weave pattern. More generally, any suitable arrangement or layout of one or more bridges 81 may be used and such bridges 81 may enable the alignment of the sub-strips 93 and the strips 92 relative to each other. Generally, the nozzle plate 470 may comprise bridges 81 formed of the same material as the frames 60. Further, the nozzle plate 470 may comprise one or more bridges 81, where at least one of said bridges 81 may be connected to said one or more frames 60. Alternatively, the bridges 81 may comprise a different material to the frames 60. Where the nozzle plate comprises one or more outer frames 75, said outer frames 75 may be arranged adjacent to and surrounding the outer perimeters of said one or more frames 60 and, where present, arranged adjacent to and surrounding one or more outer edges of said bridges 81.

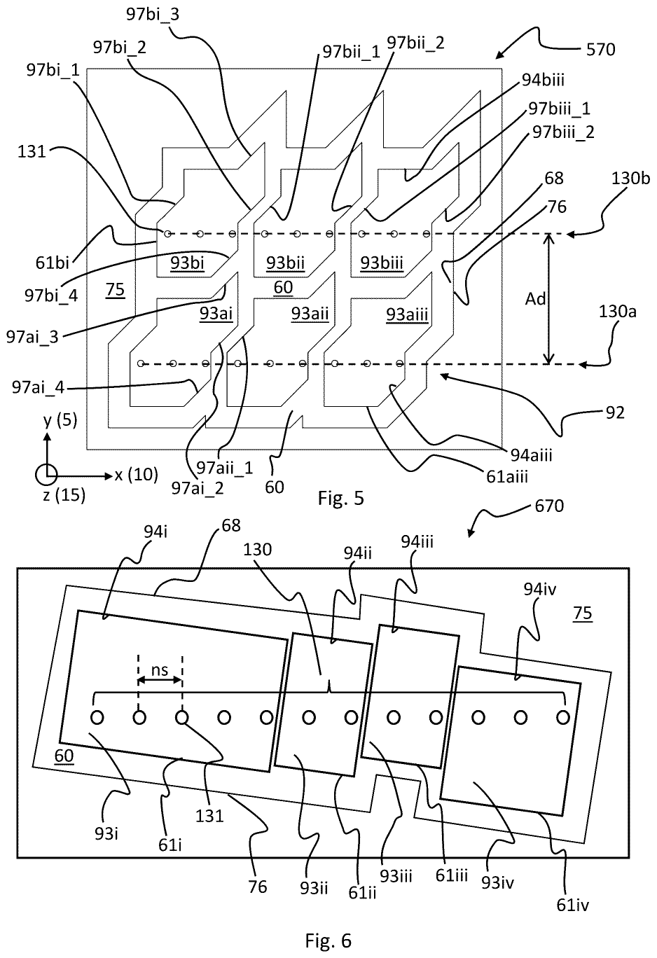

Turning now to FIG. 5, this depicts a schematic representation of a nozzle plate 570 according to another embodiment, similar to that of FIG. 2A-FIG. 2C, but where the strip 92 comprises a plurality of sub-strips 93ai-93biii arranged in a tessellating arrangement in both the array direction 10 and the spacing direction 5. It can be seen that, in this embodiment, the two arrays of nozzles 130a, 130b are contained within the one strip 92, separated by an array separation distance Ad in the spacing direction 5. It can further be seen that there are stepped portions at either end of each sub-strip 93ai-93biii in the array direction 10. For example, there are stepped portions 97bi_1, 97bi_2 on opposing sides of sub-strip 93bi in the array direction 10 and stepped portions 97bi_3, 97bi_4 on opposing sides of sub-strip 93bi in the spacing direction 5. It can be seen that there are similar features on all the sub-strips 93ai-93biii, though, for simplicity, not all are labelled, but would be labelled and numbered in the same fashion as for sub-strip 93bi, from 93ai_1-93biii_4. It may be said that in the nozzle plate 570, each sub-strip 93 comprises four or more staggered edge portions 97 arranged in two or more pairs. A first pair, for example 97_1, 97_2, may be on opposing edges of a respective sub-strip 93 in the array direction 10 and a second pair, for example 97_3, 97_4, may be on opposing edges of a respective sub-strip 93 in the spacing direction 5.

The staggered edge portions 97 may aid in aligning the sub-strips 93 relative to each other, and also relative to the strip 92 and to the frame 60, so as to position the nozzles 131 so as to form the nozzle arrays 130a, 130b. For example, where two sub-strips 93 are arranged adjacent to each other in the array direction 10, e.g., 93ai and 93aii a staggered edge portion 97ai_2 on the first sub-strip 93ai is arranged adjacent to and facing a corresponding staggered edge portion 97aii_1 on the second sub-strip 93aii in a tessellating relationship in the array direction 10. Similarly, in the spacing direction 5 a staggered edge portion 97bi_4 on sub-strip 93bi, for example, is arranged adjacent to and facing a corresponding staggered edge portion 97ai_3 on sub-strip 93ai in a tessellating relationship in the spacing direction 5.

The nozzle plate 570 of FIG. 5 comprises a frame 60 with a plurality of openings 61ai-61biii, one per respective sub-strip 93ai-93biii (not all of the openings are labelled in FIG. 5), such that each of the sub-strips 93 is surrounded by an opening 61 in the frame 60. It can further be seen that, as in FIG. 3, for example, the nozzle plate 570 comprises an outer frame 75 surrounding the frame 60. The outer frame 75 comprises an outer opening 76 such that the frame 60 is surrounded by the outer opening 76. It can be seen that the openings 61ai-61biii may preferably be conformal to the shape of the outer perimeter edges 94ai-94biii of the sub-strips 93ai-93biii. It can further be seen that the outer opening 76 is conformal to the shape of the outer perimeter edge 68 of the frame 60. It can further be seen that the shape of the outer opening 76 reflects the shape of the outer perimeter edge 68 which, in turn, reflects the shape of the outermost portions of the sub-strips 93, i.e. the shape of the outer perimeter edges 94 that comprise staggered edge portions 97 that are located adjacent to the outer opening 76.

Turning now to FIG. 6, this depicts a schematic representation of a nozzle plate 670 according to another embodiment, similar to that of FIG. 5, but where the sub-strips 93 are non-uniform and arranged in a staggered pattern so as to align the nozzle array 130 in the array direction 10. Such an arrangement may be used where, for example, different shaped sub-strips 93 may make best use of the available space on a die, or to allow for discrepancies in shape between sub-strips 93 so that the nozzles 131 can be aligned as closely as possible to their desired locations. Although not shown here, it may be understood that the respective sub-strips 93i-93vi of FIG. 6 may comprise one or more anchors 95 and/or one or more staggered edge portions 97 as described herein.

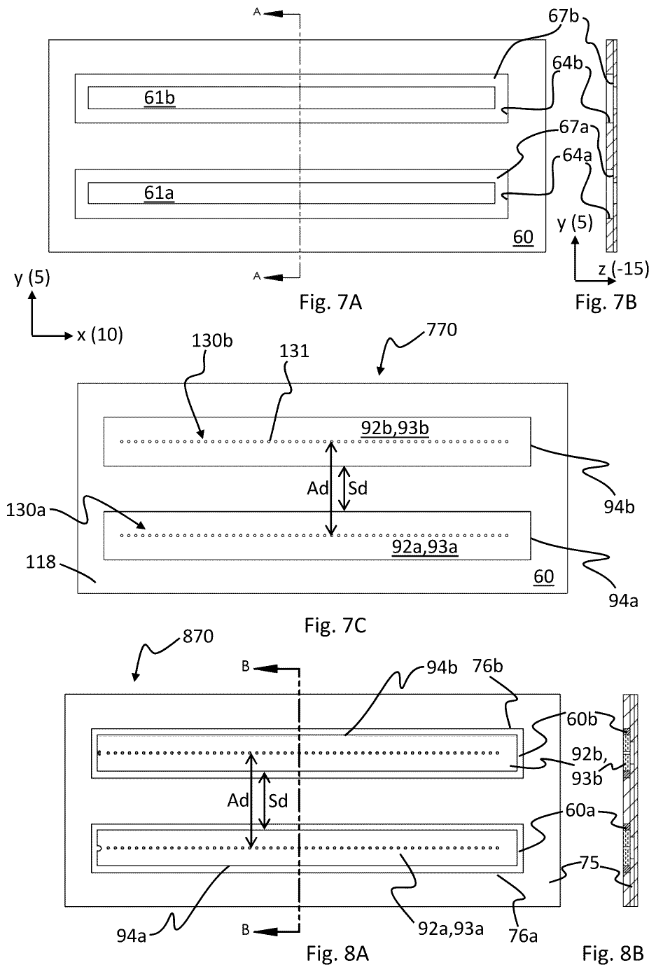

Considering now FIG. 7A, FIG. 7B and FIG. 7C, these depict, respectively, a schematic representation of part of an embodiment of a nozzle plate 770 comprising a frame 60 (FIG. 7A), an end view of the frame 60 (FIG. 7B) and a nozzle plate 770 comprising the frame 60 of FIG. 7A and FIG. 7B with two strips 92a, 92b inserted (FIG. 7C). Turning first to FIG. 7A, it can be seen that the frame 60 comprises two openings 61a, 61b each comprising a boundary edge 64a, 64b respectively. It can further be seen that the frame 60 comprises a stepped portion per opening 61a, 61b defining a supporting ledge 67a, 67b configured to underly a corresponding edge portion of the respective sub-strips 93a, 93b (see FIG. 7C). Such an arrangement may aid manufacture and operation by providing support to the strips 92.

In the arrangement of FIG. 7A-FIG. 7C, the frames 60 may comprise glass, or ceramic. Alternatively, they may comprise a polymer. A layer of adhesive and/or sealant may be placed between the supporting ledges 67a, 67b and the sub-strips 93a, 93b in order to ensure a fluidic seal, and/or to firmly attach the sub-strips 93a, 93b to the supporting ledges 67a, 67b.

It can be seen from FIG. 7C that each strip 92a, 92b comprises a plurality of nozzles 131 arranged in respective arrays 130a, 130b extending in the array direction 10. In this embodiment the strips 92a, 92b comprise a single sub-strip 93a, 93b respectively, but this is by no means limiting and in other arrangements there may be two or more sub-strips 93 per strip 92, as described above. The strips 92a, 92b are separated by separation distance Sd in the spacing direction 5. In this embodiment the spacing direction 5 is perpendicular to the array direction 10 but this is by no means limiting and, in other arrangements, two or more strips 92 may be arranged spaced apart from each other in a spacing direction 5 wherein the spacing direction 5 is at a non-parallel angle to the array direction 10.

Turning now to FIG. 8A and FIG. 8B, in this embodiment, similar to that of FIG. 7C, there is an outer frame 75 comprising a stepped portion per outer opening 76 defining a supporting ledge 67a, 67b. The supporting ledge 67a, 67b is configured to underly a corresponding edge portion of the respective sub-strips 93a, 93b, and hence the strips 92a, 92b, with a frame 60 formed in the gap between the outer opening 76 and the sub-strips 93a, 93b so as to surround the sub-strips 93a, 93b. The frame 60 may comprise an elastic material, this may be beneficial if the thermal expansion coefficients of the strips 92a, 92b differ from those of the frame 60 and/or the outer frame 75. Alternatively, there may be an additional elastic filler material placed between the frame 60 and the strips 92a, 92b to form an interface region between the strips 92a, 92b and the frame 60. If there is a difference in the thermal expansion coefficients of the frame 60 and the outer frame 75, likewise, there may be an elastic filler material located so as to form an interface region between the frame 60 and the outer frame 75.

Any of the nozzle plates 170-870, as described herein, may be assembled into a droplet ejection head. The droplet ejection head may comprise one or more nozzle plates 170-870 as described herein and one or more fluid chambers, where the fluid chambers are fluidically connected to one or more of the droplet ejection nozzles 131. The fluid chambers may comprise an actuator actuable to eject a droplet of fluid from one of said one or more droplet ejection nozzles 131 in response to ejection instructions. The fluid chambers may comprise an actuator associated with each fluid chamber and actuable so as to eject droplets via the one or more nozzles 131 associated with the respective fluid chamber. For example, one or more of the walls of the fluid chambers may be actuable so as to eject fluid droplets via the one or more nozzles. In some instances, one or more side walls of each fluid chamber may comprise a material showing piezoelectric properties and a suitable drive electrode arrangement, or the fluid chambers may comprise a roof mode actuator arrangement. However, it may be understood that other forms of actuators may also be used, provided that they are suitable to cause the ejection of fluid, via the respective nozzles 131, from an individual fluid chamber, in response to ejection instructions. A droplet ejection apparatus may comprise one or more droplet ejection heads. The droplet ejection heads may comprise one or more nozzle plates as described herein.

### Method of Manufacture

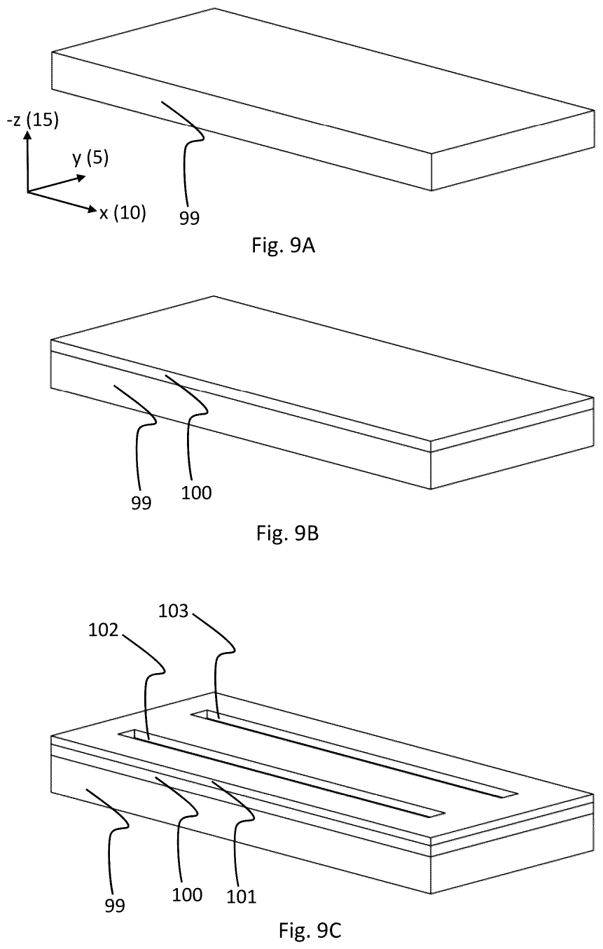

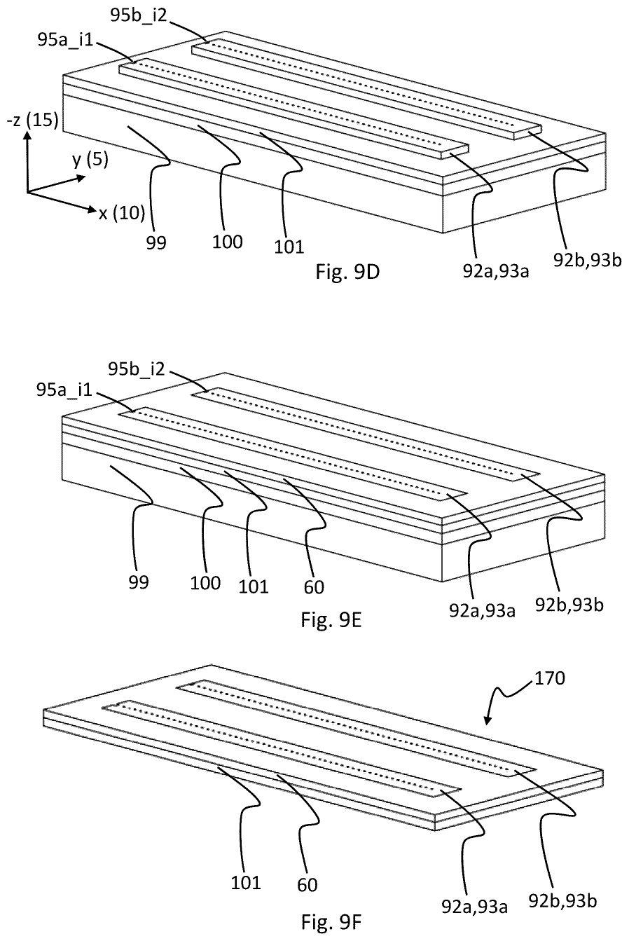

Turning now to FIG. 9A-FIG. 9E, these summarise the main steps in a method of manufacturing a nozzle plate for a droplet ejection head as described herein. The figures are based on a nozzle plate 170 such as that of FIG. 1A, but it may be understood that the method may be suitably adjusted in order to produce other embodiments of the nozzle plate of the invention. This method involves using a frame 60 surrounding the strips 92 and/or sub-strips 93 to hold them securely in place with high precision, where the frame 60 may be grown, or formed, around the strips 92 and/or sub-strips 93, for example, it may be grown, or formed using electroforming, for example or other suitable processes known in the art. The main steps are as follows:
1) As seen in FIG. 9A, a substrate 99 may be used as a support on which to build the nozzle plate 170-870. The substrate 99 may be re-useable. The substrate 99 may comprise glass or silicon. The substrate 99 may be large enough to hold more than one nozzle plate 170-870.
2) As seen in FIG. 9B, a release layer 100 may be deposited on the top surface of the substrate 99. This could be a resist layer, for example, which can be put down at an early stage and then removed (e.g., by dissolving it or using a lift-off resist) at a later stage to separate from the substrate 99. The resist layer may be similar to a photoresist, it may be a substance that is curable to form a polymer film. Alternatively, a substrate 99 with suitable properties or surface properties or coatings/treatments to facilitate separation of the nozzle plate 170-870 from the substrate 99 may be used. The substrate 99 may be glass or silicon or any suitable material.
3) Turning now to FIG. 9C, this shows a seed layer 101 which may be used as a starting point to grow the frame 75. For example, the seed layer 101 may be a seed layer for an electrophoretic process, such as an electroplating process. The seed layer 101 may be deposited on top of the release layer 100. Areas 102, 103, that may be slightly smaller than the sub-strips 93 and/or the strips 92, may be kept free of the seed layer 101 to avoid unwanted metal deposition and prevent growth of metal into the nozzles themselves, and/or to prevent contamination of the nozzle plate 170-870 adjacent to the nozzles 131. The areas 102, 103 may be kept free of the seed layer 101 by use of suitable masks, for example. The seed layer 101 may be deposited by sputtering, or by electroless plating, or the like. For example, shadow masking or a mask that may be removed by etching or use of a plasma to remove a metal mask in a later step may be used.
4) FIG. 9D shows two strips 92a, 92b, each comprising a single sub-strip 93a, 93b respectively, which may be placed with high precision onto the seed layer 101 and may be arranged so as to cover the areas 102, 103. The sub-strips 93a, 93b may comprise one or more nozzles 131; the sub-strips 93a, 93b may comprise a plurality of nozzles 131. The sub-strips 93a, 93b may be held temporarily in place, e.g., using a removable adhesive. FIG. 9D also shows anchors 95 (in FIG. 9D they are anchors 95a_i1 and anchor 95b_i_2 ) arranged on the outer perimeter edge 94 of the respective sub-strips 93a, 93b but, as previously discussed, this is by no means essential. Further, it may be understood that where the one or more sub-strips 93 comprise two or more stepped portions 97, the step of placing the sub-strips 93 may comprise arranging two or more sub-strips 93 such that two of said stepped portions 97 are arranged adjacent to each other on facing sides of said sub-strips 93. For example, as seen in FIG. 5, such that 97bii_1 is arranged adjacent to 97bi_2, and that 97bi_4 is arranged adjacent to 97ai_3. It may further be understood that the nozzles 131 may be formed in the strips 92a, 92b prior to placing them on the seed layer 101, or they may be formed as a subsequent step once the strips 92a, 92b are in situ.

It may be understood that, where there are a plurality of sub-strips 93 arranged in one or more strips 92, the sub-strips 93a, 93b may be arranged such that the nozzles 131 in a given strip 92 are aligned so as to form one or more arrays 130 extending in the array direction 10. Further, the sub-strips 93a, 93b in adjacent strips 92a, 92b, respectively, may be arranged such that the one or more arrays 130a, 130b, respectively, are parallel to each other. For example, the strips 92 may be aligned such that the droplet ejection nozzles 131 are arranged in one or more nozzle arrays 130 extending in an array direction 10.
5) Turning now to FIG. 9E, a frame 60 has been grown around the sub-strips 93a, 93b, securing their position relative to each other. It can be seen that, where anchors 95 are present on the one or more sub-strips 93a, 93b, the step of forming one or more frames 60 around the one or more sub-strips 93a, 93b may comprise forming frame material in and/or around the one or more anchors 95. The method of growing the frame 60 may comprise, for example, using an electrophoretic process, electroplating, electroforming, electrodeposition, for example, for metal layers, depending on thickness of the layer, such that the one or more frames 60 comprise an electroformed material. Alternatively, any other suitable method known in the art may be used. The one or more frames 60 may comprise a metal. For example, the one or more frames 60 may comprise nickel. Alternatively, a suitable polymer may be used, that may be deposited using an electrophoretic process, or any other suitable method known in the art.
6) Finally, as shown in FIG. 9F, the nozzle plate 170-870 may be released from the substrate 99, for example by dissolving or otherwise removing the release layer 100. Optionally, the method may further comprise removing the seed layer 101 from the nozzle plate 170-870 following the step of releasing the nozzle plate 170-870 from the substrate 99 (as seen in FIG. 1A), alternatively the seed layer 101 may be retained.

To summarise, the method of manufacturing a nozzle plate 170-870 for a droplet ejection head may comprise:
forming a release layer 100 on a top surface of a substrate 99;
forming a seed layer 101 on top of the release layer 100;
placing one or more sub-strips 93, on the seed layer 101, and, optionally, holding them in position using a temporary adhesive;
forming one or more frames 60 around the one or more sub-strips 93; such that each of said one or more sub-strips 93 fit within a corresponding opening 61 in said one or more frames 60 (in other words, such that the one or more sub-strips 93 are surrounded by openings 61 in the frames 60 and wherein each of said openings 61 is arranged adjacent to the outer perimeter edge 94 of one of said sub-strips 93); and
releasing the nozzle plate 170-870 from the substrate 99.

It may be understood that the nozzles 131 may be formed in the sub-strips 93 prior to placing them on the seed layer 101, or they may be formed at a suitable stage in the manufacture of the nozzle plate 170-870.

The method of manufacture may further comprise removing the temporary adhesive following the step of releasing the nozzle plate 170-870 from the substrate 99.

The frame 60 may be formed using an electroplating process, for example, such that the step of forming the one or more frames 60 comprises an electroplating process. The method may comprise electroplating nickel to form the one or more frames 60. Alternatively, the method may comprise electrophoresis, electroforming or electrodeposition, depending on the material being used for the frame 60.

For an embodiment such as that of FIG. 3 or FIG. 4, where there is an outer frame 75, then the method may further comprise forming an outer frame 75 prior to the step of forming said one or more frames 60. For example, the outer frame 75 may comprise a polymer. It may be understood that the method of manufacturing a nozzle plate 170-870 may comprise forming an outer frame 75 by spin-coating and photolithography, for example. This step may be performed prior to placing the sub-strips 93 on the seed layer 101. A suitable mask may be used so that the outer frame 75 is formed in the desired location(s). Alternatively, the outer frame 75 may be formed after the sub-strips 93 are placed on the seed layer 101, in which case the sub-strips 93 may be suitably masked off whilst the outer frame 75 is formed.

Alternatively, the outer frame 75 may be a pre-formed component, manufactured from any suitable material, that may be placed onto the seed layer 101 during step 4) and may be arranged so as to surround the location of the sub-strips 93, whilst leaving a gap between the outer frame 75 and the location of the sub-strips 93. The sub-strips 93 may already be in situ or placed after the outer frame 75 is in situ. In this method of manufacture, one or more cut-outs to form the outer opening(s) 76 may be pre-formed in the pre-formed component prior to attachment to the seed layer 101. Further, in this method of manufacture, the outer frame 75 may be temporarily held in place, e.g., using a removable adhesive. The outer frame 75 may comprise glass, or ceramic. The outer frame 75 may comprise a polymer. Using cheaper materials such as glass, or ceramic, or a polymer for the outer frame 75 may be beneficial in reducing the overall cost of the nozzle plate 170-870.

Whether the outer frame 75 is manufactured in situ or comprises a pre-formed component which is placed in the appropriate location, Step 5) may then comprise forming one or more frames 60 around the one or more sub-strips 93, wherein the one or more sub-strips 93 are surrounded by openings 61 in the frames 60 and wherein each of said openings 61 is arranged adjacent to the outer perimeter edge 94 of one of said sub-strips 93. Forming said frames 60 further comprises forming the one or more frames 60 within the outer frame 75 such that the frame 60 fills the space or gap between the outer frame 75 and the sub-strips 93. For example, the method of manufacturing a nozzle plate 170-870 may comprise filling the space or gap between the outer frame 75 and the sub-strips 93. Where there are two or more sub-strips 93 spaced apart by a separation distance Sd and there are bridges 81 formed between said sub-strips 93, the method of manufacture may comprise using a suitable mask to mask the bridges off whilst forming the outer frame 75. The bridges 81 may then be formed when forming the one or more frames 60, for example, by electroplating or electroforming the one or more frames 60 and, where present, the bridges 81. Where there are one or more bridges 81, the width of the bridges 81 may be suitably adjusted so that the material filling them grows at the same rate as the frame 60 that is filling the space or gap between the outer frame 75 and the sub-strips 93.

An alternative method of manufacturing a nozzle plate 170-870 for a droplet ejection head, such as those of FIG. 7A-FIG. 7C and FIG. 8A-FIG. 8B, may comprise:
forming a frame 60, 75;
forming one or more openings 61a, 61b, 76a, 76b in the frame 60, 75, such that there is a supporting ledge 67a, 67b in each of said openings 61a, 61b, 76a, 76b (see for example FIG. 7A and FIG. 7B);
placing adhesive on a portion of said supporting ledge 67a, 67b and/or said opening boundary edges 64a, 64b in said openings 61a, 61b, 76a, 76b;
placing one or more sub-strips 93, in each of said openings 61a, 61b, 76a, 76b such that a portion of said sub-strip 93 is supported by said supporting ledge 67a, 67b; and
curing said adhesive so as to attach said sub-strips 93 to said frame 60, 75.

Where the method comprises placing the sub-strips 93 in the openings 61a, 61b, 76a, 76b such that they are supported by the supporting ledge, placing adhesive or filler around the sub-strips 93 may be done such that the gap between the sub-strips 93 and the openings 61a, 61b, 76a, 76b is filled, as seen in FIG. 8B. In other words, the method of manufacture may comprise forming one or more frames 60 around the one or more sub-strips 93 such that each of said one or more sub-strips 93 fit within a corresponding opening 61 in said one or more frames 60.

For some arrangements, the method of manufacturing a nozzle plate 170-870 as described herein may comprise the step of forming said one or more openings 61a, 61b, 76a, 76b in said frame 60 and/or said outer frame 75 using etching or sandblasting. In some methods of manufacture, prior to the step of placing the sub-strips 93 in the openings 61a, 61b, 76a, 76b, one or more actuator components may be attached to one or more of said sub-strips 93. The nozzle plate 170-870 may comprise an arrangement where the boundary edge 64 of the one or more openings 61 is formed around the shape of the outer perimeter edge 94 during manufacture.

### General Considerations

In general, a nozzle plate 170-870 as described herein may comprise: one or more strips 92, comprising one or more sub-strips 93, wherein said one or more sub-strips 93 comprise one or more droplet ejection nozzles 131; and one or more frames 60, comprising one or more openings 61; wherein each of said one or more sub-strips 93 fit within a corresponding opening 61 in said one or more frames 60; such that said one or more strips 92a, 92b and said one or more frames 60 together present a media facing surface 118 of the nozzle plate 170-870.

In other words, wherein each of said one or more sub-strips 93 is surrounded by one of the one or more openings 61 and wherein each of said openings 61 is arranged adjacent to the outer perimeter edge 94 of one of said sub-strips 93, such that said one or more strips 92 and said one or more frames 60 together present a media facing surface 118 of the nozzle plate 170-870. Where the one or more frames 60 are surrounded by an outer frame 75 the media facing surface 118 of the nozzle plate 170-870 may further comprise the outer frame 75. It may be understood that the media facing surface 118 formed by the one or more strip(s) 92, respectively comprising one or more sub-strips 93, and the one or more frame(s) 60 and (where present) one or more outer frames 75, may be planar. It may be understood that where the nozzle plate 170-870 comprises a single strip 92 there is no separation distance Sd, and the y-direction indicates the direction perpendicular to the array direction 10 and the ejection direction 15.

It may be understood that the nozzle plate 170-870 may comprise one or more nozzle arrays 130 where the droplet ejection nozzles 131 are arranged in a repeating pattern. The nozzle plate 170-870 may comprise droplet ejection nozzles 131 arranged in a staggered pattern.

The present invention provides for one or more strips 92 which may comprise one or more sub-strips 93 and a means of mounting the strips in a frame 60, where the frame 60 is formed of a lower cost material and constitutes the remaining surface of the nozzle plate 170-870. Such an arrangement provides the desired robustness in the vicinity of the nozzles, but at reduced cost compared to an all-robust nozzle plate, for example, a silicon nozzle plate. This reduced cost is possible because a greater number of smaller strips can be made from, for example, a standard 6-inch silicon wafer, and it is not necessary for the full surface of the nozzle plate 170-870 to be made of silicon or another such expensive material. However, when placing individual strips (for droplet ejection heads with more than one row of nozzles, or to make a longer row of nozzles) maintaining permanent high positioning tolerance relative to each other is important but difficult. The present invention proposes means to position the strips relative to each other with sufficiently high tolerances.

It may be generally understood that, where a respective strip 92 comprises a single sub-strip 93, as in FIG. 1A-FIG. 1B, FIG. 3, FIG. 4, FIG. 7C, FIG. 8A-FIG. 8B, FIG. 9F, then such a sub-strip 93 may comprise one or more staggered edge portions 97 arranged on the outer perimeter edge 94 of the strip 92 at one or more locations (i.e., on one or more sides if the strip 92 is largely rectangular in shape) in order to aid in alignment and positioning of a respective strip 92 relative to the frame 60 adjacent to it. This may be as well as or instead of anchors 95 as described above. For example, there may be one or more staggered edge portions 97 at one or both ends in the array direction 10, or there may be one or more staggered edge portions 97 along one or both of the sides parallel to the array direction 10. A nozzle plate 170-870, as described herein, may comprise three or more sub-strips 93, wherein at least two of said sub-strips are arranged adjacent to each other in a nozzle array direction 10, and at least two of said sub-strips 93 are arranged adjacent to each other in a spacing direction 5. In such nozzle plate 170-870 the staggered edge portions 97 allow alignment of the three or more sub-strips 93 in a tessellating relationship.

The fluid chambers 121 described herein may comprise an actuator associated with each fluid chamber 121 and actuable so as to eject droplets via the one or more nozzles 131 associated with the respective fluid chamber 121. For example, one or more of the walls of the fluid chambers 121 may be actuable so as to eject fluid droplets via the one or more nozzles 131. For example, one or more side walls of each fluid chamber 121 may comprise a material showing piezoelectric properties and a suitable drive electrode arrangement, or the fluid chambers 121 may comprise a roof mode actuator arrangement. However, it may be understood that other forms of actuators may also be used, provided that they are suitable to cause the ejection of fluid, via the respective nozzles 131, from an individual fluid chamber 121, in response to ejection instructions.

1. A nozzle plate for a droplet ejection head, the nozzle plate comprising:
one or more strips, including one or more sub-strips, wherein said one or more sub-strips include one or more droplet ejection nozzles; and
one or more frames, including one or more openings;
wherein each of said one or more sub-strips fit within a corresponding opening in said one or more frames, and
wherein said one or more strips and said one or more frames together present a media facing surface of the nozzle plate.

2. The nozzle plate according to claim 1, wherein each of said one or more sub-strips is surrounded by one of said one or more openings; and
wherein each of said openings is arranged adjacent to the outer perimeter edge of one of said sub-strips.

3. The nozzle plate according to claim 1, wherein a boundary edge of said one or more openings is conformal to the shape of said outer perimeter edge.

4. The nozzle plate according to claim 1, wherein said strips are aligned such that said droplet ejection nozzles are arranged in one or more nozzle arrays extending in an array direction.

5. The nozzle plate according to claim 1, comprising two or more strips wherein adjacent strips are offset by a separation distance in a spacing direction.

6. The nozzle plate according to claim 1, wherein said one or more frames includes one of:
an electrophoretic material;
metal, optionally nickel;
glass, or ceramic; or
polymer.

7. (canceled)

8. (canceled)

9. (canceled)

10. (canceled)

11. The nozzle plate according to claim 1, wherein said sub-strips include one or more anchors for anchoring said one or more sub-strips within said one or more frames; optionally wherein said anchors are arranged on the outer perimeter edge of said sub-strips; optionally wherein said anchors are protrusions and/or indentations.

12. (canceled)

13. (canceled)

14. The nozzle plate according to claim 1, wherein the one of more frames include a stepped portion defining a supporting ledge configured to underly a corresponding edge portion of a sub-strip.

15. The nozzle plate according to claim 1, wherein said sub-strips include one or more staggered edge portions on said outer perimeter edge.

16. The nozzle plate according to claim 1, wherein each said sub-strip includes staggered edge portions each arranged on opposing edges of the sub-strip.

17. (canceled)

18. The nozzle plate according to claim 1, wherein each said sub-strip includes four or more staggered edge portions arranged in two pairs, each pair being on opposing edges of said sub-strips

19. The nozzle plate according to claim 1, comprising two or more sub-strips wherein a staggered edge portion on a first of said sub-strips is arranged adjacent to and facing a corresponding staggered edge portion on a second of said two or more sub-strips in a tessellating relationship.

20. The nozzle plate according to claim 1, comprising three or more sub-strips wherein at least two of said sub-strips are arranged adjacent to each other in a tessellating relationship in a nozzle array direction and at least two of said sub-strips are arranged adjacent to each other in a tessellating relationship in a spacing direction and wherein said stepped portions allow alignment of said three or more sub-strips in a tessellating relationship.

21. The nozzle plate according to claim 1, comprising two or more strips arranged spaced apart from each other in a spacing direction wherein said spacing direction is at a non-parallel angle to an array direction

22. The nozzle plate according to claim 21, comprising bridges extending in the spacing direction and arranged between adjacent spaced apart strips so as to control the distance between said strips.

23. The nozzle plate according to claim 22, wherein the frames include said bridges formed of the same material as said frames; and/or wherein said bridges are connected to said one or more frames.

24. (canceled)

25. The nozzle plate according to claim 1, comprising one or more outer frames arranged adjacent to and surrounding the outer perimeters of said one or more frames; optionally wherein the one or more outer frames includes polymer.

26. The nozzle plate according to claim 22, comprising one or more outer frames arranged adjacent to and surrounding the outer perimeters of said one or more frames, wherein the one or more outer frames are arranged adjacent to and surrounding one or more outer edges of said bridges.

27. A droplet ejection head comprising one or more nozzle plates according to claim 1, and one or more fluid chambers fluidically connected to one or more of said droplet ejection nozzles; wherein said fluid chambers include an actuator actuable to eject a droplet of fluid from one of said one or more droplet ejection nozzles in response to ejection instructions.

28. A droplet ejection apparatus comprising one or more droplet ejection heads according to claim 27.

29-42. (canceled)
